(19) United States
(12) Patent Application Publication
(10) Pub. No.: US 2007/0131507 A1
(43) Pub. Date: Jun. 14, 2007

(54) Electric actuators for clutch and/or sequential gearbox operation in motor vehicles

(75) Inventor: Maurizio Bigi, Novi di Modena (IT)

Correspondence Address: GRAYBEAL, JACKSON, HALEY LLP, 155 - 108TH AVENUE NE, SUITE 350, BELLEVUE, WA, 98004-5901, US

(73) Assignee: Automac Engineering S.R.L.

(21) Appl. No.: 11/604,113

(22) Filed: Nov. 22, 2006

Related U.S. Application Data
(63) Continuation of application No. 10/892,405, filed on Jul. 14, 2004, now abandoned.
Application No. 10/892,405 is a continuation-in-part of application No. 10/270,260, filed on Oct. 11, 2002, now abandoned.
Application No. 10/270,260 is a continuation-in-part of application No. PCT/IT01/00179, filed on Apr. 10, 2001.

(30) Foreign Application Priority Data
Apr. 11, 2000 (IT) MO2000A000072

(51) Int. Cl. B60W 10/02

(52) U.S. Cl. 192/3.56

(57) ABSTRACT

The electric actuator, for the control of the clutch and/or sequential gearbox in motor vehicles, includes an electric motor and a mechanism for transforming rotary motion into linear motion of the actuator element, and has a thrust crank or at least one cam that performs a complete rotation returning to its starting position, whether it be the control for the clutch, the gearbox, or both. The cam is advantageously made in the form of a template, fashioned in a plate sliding in a guide, in which a crank stud is positioned rotating with the action of the electric motor. Combined, compact embodiments of the two actuators for the clutch and sequential gearbox are included, as well as: mechanical disconnecting safety mechanisms for operation of the gearbox lever.

### PRIORITY CLAIM

The present application claims priority from commonly owned U.S. patent application Ser. No. 10/892,405, filed 14 Jul. 2004, which is a continuation-in-part application which claims priority from U.S. patent application Ser. No. 10/270,260, filed Oct. 11, 2002, which is a continuation-in-part application which claims priority from PCT/IT01/00179, published in English, filed Apr. 10, 2001, based on Italian patent Application No. MO2000A000072, filed Apr. 11, 2000; this application also claims priority from Italian Application No. MO2000A000072, filed Apr. 11, 2000.

TECHNICAL FIELD

The invention concerns: electric actuators for controlling the clutch and/or the sequential gearbox in motor vehicles, in which the release of the friction clutch occurs by means of the action of a device equipped with a template; similarly, the actuation of the sequential gearbox is achieved by means of a template of a different actuator, the two actuators possibly being coupled for the simultaneous control of the said clutch and sequential gearbox.

### BACKGROUND

Prior art already comprises actuator devices for sequential gearboxes consisting of hydraulic cylinders in which the pressure acting in the said cylinders selects, in sequence, the higher or lower gear; similar types of these actuators are described in U.S. Pat. No. 6,348,023 B1 and in IT 1310174 B1.

The said actuators consist of two single acting cylinders, whose pistons are connected to each other on the same stem on the opposite side from the pressure chamber. A drain connection is positioned in the middle between the cylinders and the pistons when in their neutral position; the pressure chambers are controlled by three-way control valves which connect each chamber, alternatively to the high pressure line, for actuation, or the discharge line to end actuation on that side; the central position of the stem with two pistons is obtained by means of two cups with collars on the pressure chamber side, which when subjected to pressure in both chambers define a fixed central position, by means of the collars and appropriate stroke limiters.

Prior art also comprises mechanical actuators for clutch control in motorcycles, as described in WO 0061430 A1, in which the mechanical control acts on a lever which, by means of a rack-and-pinion transmission, moves the clutch plate; the return stroke is ensured by the springs of the clutch plate. Is also used a manual hydraulic control consisting of a single acting hydraulic cylinder acting on the control rod of the clutch plate, fed by a small pump connected to the manual control lever operated by the user.

The need for both manual and automatic operation is felt particularly when the gearbox is operated remotely. In fact, in the case of motorcycles, the dual operating mode, both of the gearbox but more importantly of the clutch is seen as a significant safety feature.

With remote control operation the command which carries out the sequential gearbox, to operate correctly also has to operate the clutch, that is, the said lever with pinion and rod with rack, or the manual hydraulic control, with single acting cylinder, have to be remote controlled; because of the way they are configured they do not enable indifferently automatic or manual operation, that is with remote control.

Also, in the field of motor vehicles, prior art comprises, as described in U.S. Pat. No. 5,678,673 A, an actuator to operate the clutch consisting of an electric motor which by means of a pinion coupled to a portion of crown gear turns a lever which acts by means of a rod on the clutch; the said lever is connected to a spring which compensates the opening force of the clutch. Moreover, such an actuator needing to invert the sense of rotation of the electrical motor during the operating cycle of the clutch, does not enable the sense of rotation of the said lever to be made not predetermined, as it has an obligatory direction. Furthermore, the inversion of the sense of rotation is a limiting factor for the speed of operation of the actuator.

The combination of one actuator for the clutch mechanism and one for the gearbox is known in the prior art and described in U.S. Pat. No. 5,881,853 A, in which a crank/rod mechanism is connected to a control rod of the gearbox; the mechanism is coupled by an auxiliary clutch mechanism to a cam mechanism acting on a control lever of the clutch of the vehicle. The actuator means is not able to maintain a rigid connection between the two actuators, because the clutch actuator may rotate indifferently clockwise or anticlockwise, but the crank/rod mechanism has to be actuated with a very different timing from the clutch actuator. However, the above-described gearbox actuator, applied on its own, requires control signals to determine the right timing to stop the rotation of the mechanism or to permit the free return stroke.

Furthermore, in the prior art is known, in the field of the vehicle door-locking mechanisms, the U.S. Pat. No. 4,876,909 A that describes a system to control and actuate the locking of the doors of a vehicle like a car. The description explains the control system and related switches very well, but it describes the actuator schematically by a slide having two stops settled with two different distances on the slide, one in the stroke direction and one perpendicular to it, to permit the pin to pass freely through them, when manually acting on the door-locking mechanism. As a result, the slide shows, as a mapping similar to a flag with a centered cross, the two distances, and the two stops are similar to the two opposite squared diagonal areas. Moreover, the mentioned pin of the actuator is a spring biased pin that permits retraction, which causes disengagement with the two stops, when an over stroke occurs to the slide or the pin steps out of the longitudinal path. The present prior art does not show any solution to overcome the limitation of the previously described patent because even the door-locking actuator, due to a non-symmetric constitution on a single axis, needs to turn in one direction only.

Also for the gearbox there are electric motors, possibly with speed reducing mechanisms, that control the gear shift drum directly or actuate the gear lever in sequential gear boxes.

Also, the high powers of modern motorcycle engines require a considerable force to be exerted by the rider to operate the clutch.

Such prior art may be subject to considerable improvement with a view to the possibility of making actuators for clutches and sequential gearbox with a low cost and simple operation.

From the foregoing emerges the need to resolve the technical problem of inventing a configuration of the actuator controlling the clutch and/or the sequential gearbox which is simple to construct and which is reliable, the two actuators possibly being coupled in construction and operation.

### SUMMARY

The invention resolves the said technical problem by adopting: an electric actuator that controls a sequential gearbox in motor vehicles, comprising:
an electric motor and a mechanism for transforming rotary motion into linear motion of an actuator element, wherein the actuator comprises: axial actuator means set directly on a translation axis of said actuator element;
the actuator means have main working parts with working profiles having symmetrical development to an axis normal on the translation axis; the means allow multiple consecutive gear selections on a direction of rotation of the motor and corresponding translation of the actuator means, either a higher gear or a lower one, with corresponding full rotation of a crank stud, clockwise or counterclockwise, of the mechanism;
the actuator means after the gear selection returning to a same starting position, for internal and/or external action of controlled element or of the actuator itself; the actuator means allowing, indifferently, the manual or automatic controlling the sequential gearbox;
the mechanism, for transforming the rotary motion into linear motion, is a template, with a profile fashioned in a plate sliding on a corresponding guide, in which is positioned the crank stud made to rotate by the said electric motor;
the working profiles of the template have the axis of symmetry intersecting the axis of rotation of the crank in the starting position.

Further adopting, in another form of embodiment for the gearbox actuator: after gear selections, the actuator means returning to a same starting position with the aid of elastic means acting on the axis to the actuator element; and advantageously a controlled gearbox rod is centered mechanically on the guide of the actuator by means of counter-acting springs to constitute the elastic means.

Adopting, in another form of embodiment for the gearbox actuator: the template consisting of two first working profiles which are each one parallel to the other on opposite sides of the axis of symmetry, and of two second working profiles each one coaxial to the other and tangential to a circumference traced by the stud and parallel to the translation axis of the actuator means.

Adopting in a further preferred embodiment for the gearbox actuator: the template consisting of two first working profiles which have a curvature, on opposite sides of the axis of symmetry, between a template side, parallel to the translation axis, and a top of the two first working profiles; are also provided two second working profiles each one coaxial to the other and tangential to a circumference traced by the stud and parallel to the translation axis of the actuator means; advantageously the template presents the two first working profiles which have the curvature with a radius similar or equal to the sum of the crank radius and of the radius of the stud; in addition the template presents the top between the two first working profiles registered in height to define the timing of stand in full stroke position of the actuator means.

Adopting also, in a further preferred embodiment of the gearbox actuator: the actuator has a mechanical disconnecting mechanism, with preloaded elastic element, positioned between the said electric actuator and a control pin of the sequential gearbox.

Further adopting, in another form of embodiment for the gearbox actuator: the disconnecting mechanism has an axial operating direction and is positioned directly on a control lever of the sequential gearbox; or the disconnecting mechanism intervenes directly on the rotation of the pin of the sequential gearbox controlled by a rod of the said electric actuator of the gearbox.

Adopting, in a further form of embodiment of the gearbox actuator: the actuator element is connected to the plate containing the template in an elastic manner so as to allow over-run of the control stroke; and advantageously, the electric actuator has a sensor for detecting the starting position of the template of the actuator and, more advantageously, a sensor to detect the angular position of the stud crankshaft.

Adopting, in a preferred embodiment, in the case of the clutch actuator: an electric actuator for controlling a clutch in motor vehicles, comprising:
an electric motor and a mechanism for transforming rotary motion into linear motion of an actuator element, wherein the actuator comprises: axial actuator means set directly on a translation axis of an actuator element;
the actuator means have main working parts with working profile having symmetrical development to the translation axis; the means allow multiple consecutive operations on a direction of rotation of the motor and corresponding translation of the actuator means , with corresponding full rotation of a crank stud, clockwise or counterclockwise, of the mechanism;
the actuator means after an operation returning to a same starting position, for internal and/or external action of controlled element or of the actuator itself;
the mechanism, for transforming the rotary motion into linear motion, is a template, with a profile fashioned in a plate sliding on a corresponding guide, in which is positioned the crank stud made to rotate by the said electric motor;
the working profile of the template have the axis of symmetry intersecting the axis of rotation of the crank in the starting position.

Adopting, in a further preferred embodiment, in the case of the clutch actuator: the electric actuator presents elastic means allowing energy accumulation; the elastic means are placed axially to the actuator element to compensate the forces generated by internal springs of the clutch; or the electric actuator presents the elastic means for energy accumulation consisting of a compensation spring, to compensate the forces generated by internal springs of the clutch.

Adopting, furthermore, in another form of embodiment of the clutch actuator: the electric actuator has the actuator element comprising a hydraulic pump connected to the plate containing the said actuator means; or the actuator element comprising a metallic cable connected to the plate containing the actuator means.

Adopting, finally, in a further preferred embodiment of the clutch actuator: the electric actuator has an unidirectional rigid connection between the sliding plate with the template and a rigid rod, to control the clutch: having also a locking tooth of the rod or an extremity of it to abut against a shoulder or in a slot made in the rod: the said tooth is disengaged when controlled by means of an electromagnet is in de-energized position.

An electric actuator for controlling the clutch and the sequential gearbox of motor vehicles, wherein the actuator comprises and actuator for the gearbox and an actuator for the clutch as described above: both actuators being driven by the same electric motor.

Set for modifying the control clutch and the sequential gearbox of a motorcycle, comprising at least an actuator for the gearbox and an actuator for the clutch as described above.

The advantages obtained with this invention are: operating the control of the friction clutch by means of the template is economical and correct operation is ensured, and it is versatile in terms of where it is positioned in the vehicle; the crank stud is offloaded of the residual tension or thrust generated by operating the clutch due to the presence of the compensating springs; furthermore, the force generated by the electric motor is reduced and optimized by the geometry of displacement of the template; importantly, also, both the hydraulic actuator and that operated by the metal cable are extremely economical.

Furthermore, the sequential gearbox actuator is of very simple construction and does not have any of the complications of the prior art hydraulic actuators; the said actuator may be easily and economically manufactured and proper operation is assured. Furthermore, the template actuator for operating the sequential gearbox is highly versatile, as it may be indifferently power assisted or manually operated and it may be coupled to clutch operating actuator, to operate the clutch in a suitably synchronized manner, thereby ensuring proper operation of both controls. Furthermore, when the gearbox actuator is coupled to the clutch actuator, and rotates with it, it is still possible to control the clutch, to allow the degree of slippage necessary for the dynamic requirements of the vehicle, even with the automatic control, that is, managed by the vehicle control logic, as well as, naturally, with the manual intervention of the driver, without having to operate the gear lever. Also, both the actuator for the clutch only and the two actuators for clutch and gearbox may be fitted to the vehicle after it is manufactured, thereby implementing an advantageous improvement to the said vehicle; finally the assembly may be carried out by the user because the said actuator or actuators are easy and economical to install.

Finally, with the use of the locking tooth with electromagnetic control of the lever in the clutch actuator, it is possible to keep the clutch of the vehicle disengaged even in situations where multiple gear changes are required, generally when changing down, in a short space of time and without the need to engage the clutch with each change of gear. In this case a further advantage is the possibility of stopping the vehicle with a gear selected and to select any gear without the vehicle moving with engine on.

### BRIEF DESCRIPTION OF THE DRAWINGS

Some embodiments of the invention are illustrated, purely by way of example, in the fifteen tables of drawings attached in which:

FIG. 1 is the longitudinal section of the hydraulically operated clutch control actuator with template, as described in the present invention;

FIG. 2 is a perspective view, with the cover missing from the template, of the actuator of FIG. 1;

FIGS. 3 to 8 are schematic representations of the template and of the crank stud of a clutch actuator, in the various positions during the operating cycle, starting from disengagement to reengagement;

FIG. 9 is a diagram showing the forces that act on the template and its movement during a stroke;

FIG. 10 is the longitudinal section of a sequential gearbox control actuator with template operated by metal wire;

FIG. 11 is the longitudinal section of a sequential gearbox control actuator with template, according to the invention;

FIG. 12 is the prospective view, with the cover missing from the template, of the actuator in FIG. 11;

FIG. 13 is the prospective view of the lever mechanism coupling the control of the sequential gearbox of a motorcycle with the actuator with template, according to the present invention;

FIG. 14 is the prospective view of the sequential gearbox and clutch control actuator for a motorcycle, both coupled to the same drive motor;

FIG. 15 is the lateral view of a further embodiment of the group of actuators for clutch/gearbox, viewed from the side of the gearbox actuator, without lateral cover and partially sectioned;

FIG. 16 is the prospective view of the mechanical axial disconnecting mechanism for the gearbox lever;

FIG. 17 is section XVII-XVII of FIG. 15 limited to the sectioned plane;

FIG. 18 is a longitudinal prospective view of the group of actuators with a further embodiment of the mechanical disconnecting mechanism showed sectioned, in this case rotational and positioned directly on the pin of the sequential gearbox lever;

FIG. 19 is the prospective view of the group of actuators and lever mechanism of the gearbox operation in the previous Figure;

FIG. 20 is the side view of the group of actuators for clutch/gearbox viewed from the clutch actuator side, without the lateral cover and partially sectioned;

FIG. 21 is the enlarged view of the template and the crank stud of the clutch actuator of the previous Figure, slightly rotated from the neutral position with clutch engaged;

FIG. 22 is a view analogous to the previous one of the clutch actuator, but with locking tooth, with electromagnetic control, that keeps the clutch disengaged, pressed against the rigid control lever;

FIGS. 23a to 23c are schematic representations of the template and of the crank stud of gear box actuator means, in null, start and stop engagement positions during an operating cycle, of a first embodiment of template profiles;

FIGS. 24a to 24c are schematic representations of the template and of the crank stud of gear box actuator means, in null, start and stop engagement positions during an operating cycle, of a second and improved embodiment of template profiles;

FIGS. 25a to 25c are schematic representations of the template and of the crank stud of gear box actuator means, in null, start and stop engagement positions during an operating cycle, of a third and more suitable embodiment of template profiles;

FIG. 26 is a diagram showing the strokes of the actuator means obtained by the different template profiles of previous FIGS., 23 to 25, compared each other with the compensation of dimensions of means to show the effect on the timing of actuation.

### DETAILED DESCRIPTION

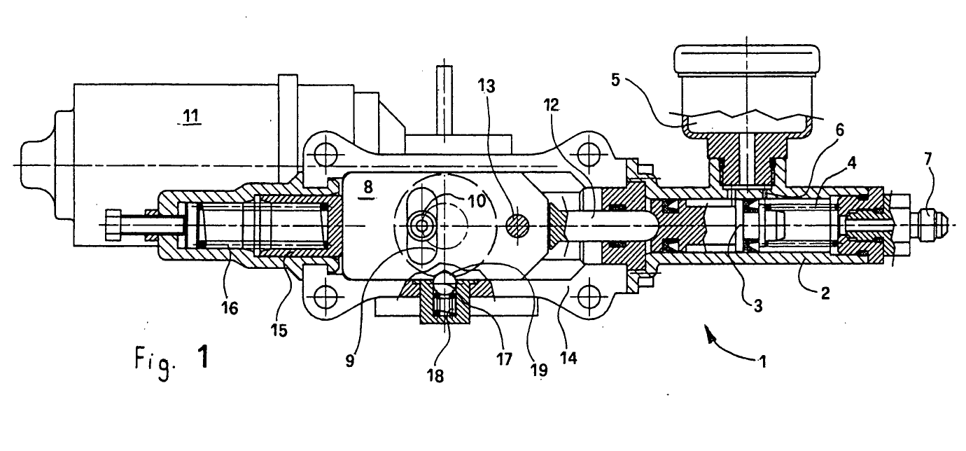

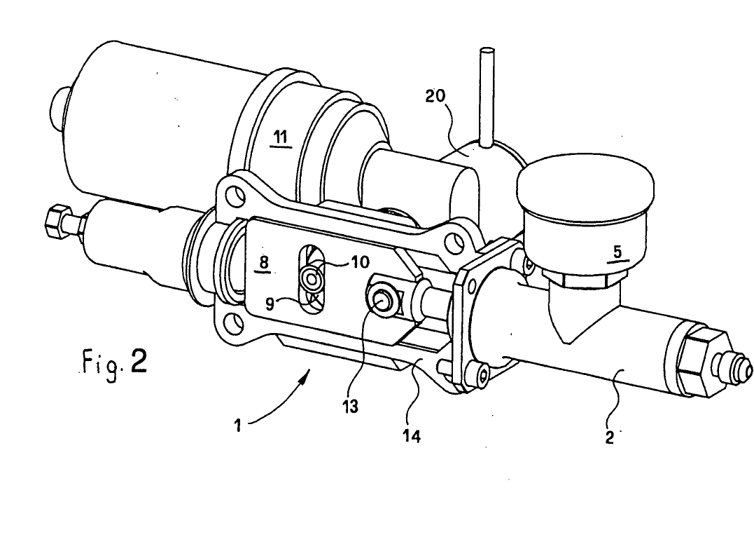

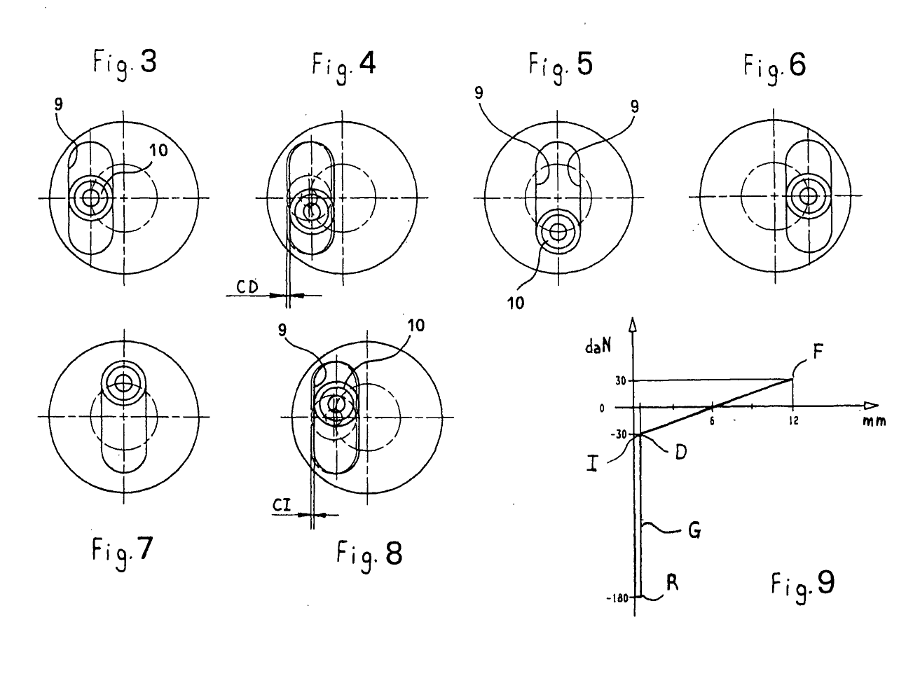

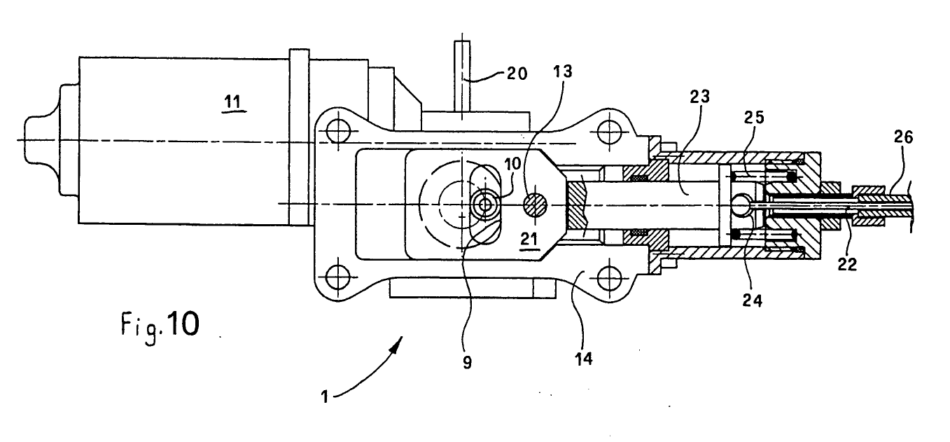

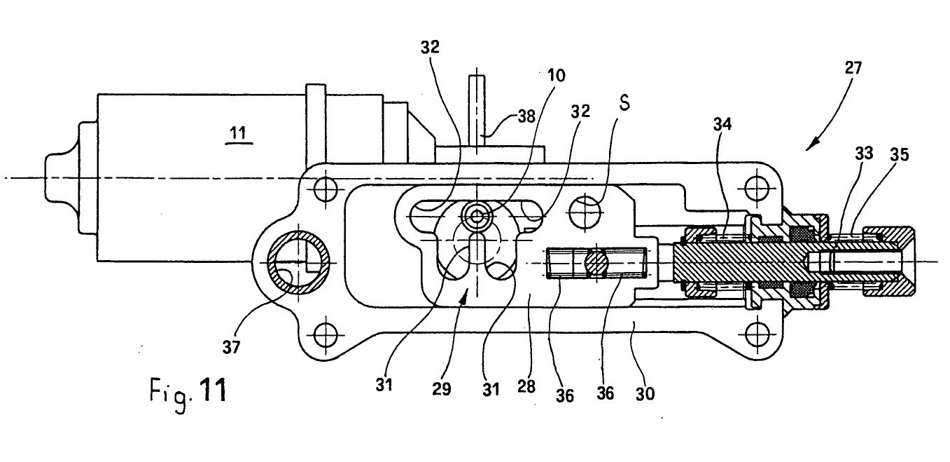

The figures show:
1, FIG. 1, the hydraulic control mechanism of the clutch, having pump 2, with piston 3 of cylinder 4 and reservoir 5, connected to the pump by means of inlet tubes 6;
7, the connection of the supply tube for the hydraulic fluid to the clutch, here not shown;
8, the plate in which the template 9 is fashioned coupled to the crank stud 10 made to rotate on command by gear reducer 11;
12, the lever connected, by means of pin 13, to the said plate and in maintained contact with the said piston 3; 14, the guide of the said plate 8;
15, the reaction cup for the return stroke of the said piston 3, against the reaction of the compensating spring 16, adjustable so as to reduce the loads on the mechanism during operation of the clutch;
17, a sphere pushed by spring 18 to sit indent 19, so as to define fixed position of the said crank;
20, FIG. 2, the position sensor of the clutch lever;
CD, FIG. 4, the initial displacement in the disengagement movement of the clutch and CI, FIG. 8, the final stroke of the engagement movement;
R, FIG. 9, the point on the diagram indicating the neutral position of the mechanism illustrated in FIG. 3;
D, the point in the diagram indicating the initial stage of disengagement, illustrated in FIG. 5;
F, the point in the diagram indicating the complete disengagement, illustrated in FIG. 6;
I, the point in the diagram indicating the completed engagement, illustrated in FIG. 7;
G, the loading vector of the compensating spring from I to R, illustrated in FIG. 8, or the unloading vector from R to D, illustrated in FIG. 4;
21, FIG. 10, a plate with template 9, analogous to the preceding one but shorter for operation with the metal cable 22 of the clutch control, not shown;
23, the connecting stem between the said plate 21 and the clamp 24, holding said cable 22;
25, the spring compensating the forces on the mechanism;
26, the sheath of the said metal cable.

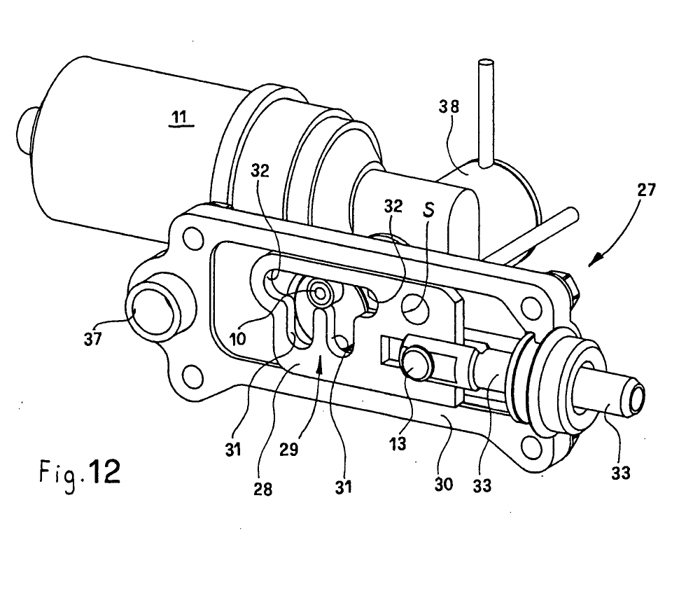

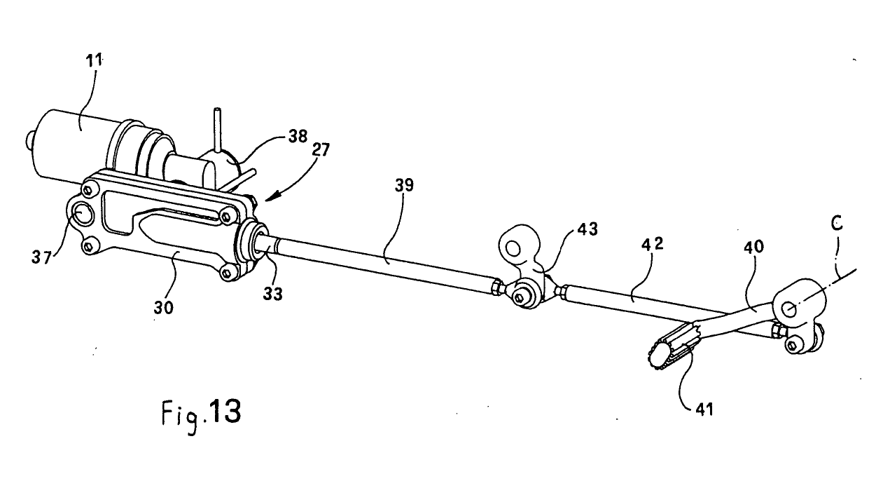

The figures also show:
27, FIG. 11, the control actuator of a sequential gearbox, in which the plate 28, with template 29, is made to slide in guide 30;
the said template consists of two guiding profiles 31, each with axis tangential to the circumference followed by the said crank stud 10 and parallel to each other, as well as of other profiles 32, coaxial and tangential to the said circumference, in a perpendicular direction to profiles 31 and parallel to the guide 30;
33 the rod connecting control lever of the gearbox; the said rod is positioned by counter-acting springs 34, 35 in both directions, whereas it is elastically connected with pin 13 to the said plate 28 by means of the over-run compensation springs 36;
S, the positioning hole for a sensor which detects the neutral position of the actuator 27, to detect manual interventions and to prevent the automatic intervention of the actuator;
37 the fulcrum of rear suspension of the actuator;
38, FIG. 12, a sensor to detect the angular position of the stud crankshaft during operation;
39, FIG. 13, the extension of the said rod 33;
40, the pedal control, on axis C, determining the rotation of the sequential gearbox selector, not shown;
42, a rod connecting the said pedal control 40 to the rod 39;
43, an oscillation arm of the said rods.

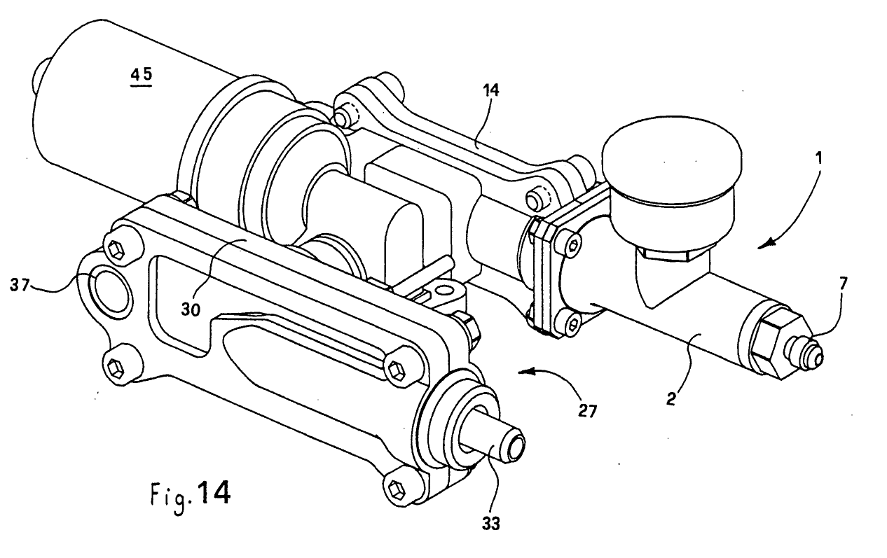

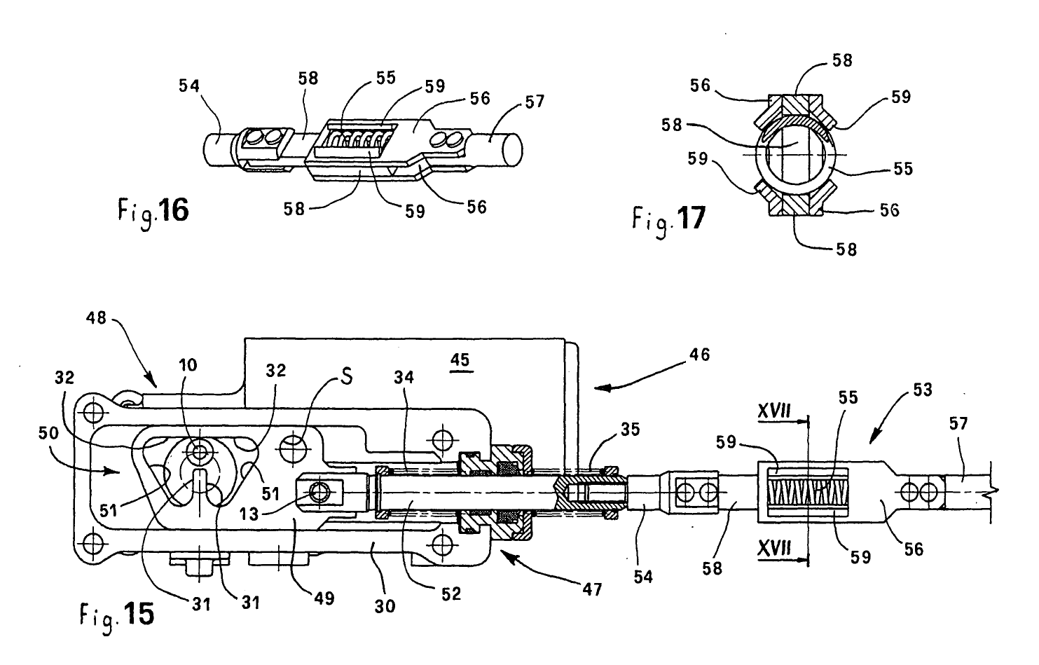

The figures also show:
44, FIG. 14, the group of two actuators I and 27, for the simultaneous control of the clutch, here hydraulically operated, and the sequential gearbox;
45, the single electric motor reducer that synchronously activates the pins that couple with the templates 9 and 29, to act simultaneously and with a single control, from the power assisted control mechanism, not shown;
46, FIG. 15, the group of two actuators in compact form 47 for the sequential gearbox and 48 for the clutch;
49 the plate in which template 50 is fashioned, analogous to template 29, but having straight profiles 51 joining profiles 31-32 (and 32-31) following on from each other;
52, the rigid rod connected rigidly with pin 13 to the said plate 49 and subjected to the centering action of the springs 34 and 35;
53, the mechanical axial disconnecting device rigidly connected to the control lever 54 of the sequential gearbox control: the said disconnecting device consists of a double housing for the preloaded compression spring 55, in which the external part 56 is rigidly connected to the rod 57, that is an extension of rod 54, and the internal part 58 is rigidly connected to the rod 54;
59, inclined portions of the said external part to contain and guide the said spring 55 preloaded to a fixed value;
60, FIG. 18, the rotational disconnecting device, placed between the control lever 61, to which is connected rod 42, and the pin 62 for activating the sequential gearbox on axis C;
63, the rotational spring, between whose end portions 64, preloaded to a fixed value, are held pin 65, rigidly fixed to the said arm 61, and pin 66 rigidly fixed to the gearbox lever 40, splined on said pin 62: the lever is rotationally coupled to the said pin 62.

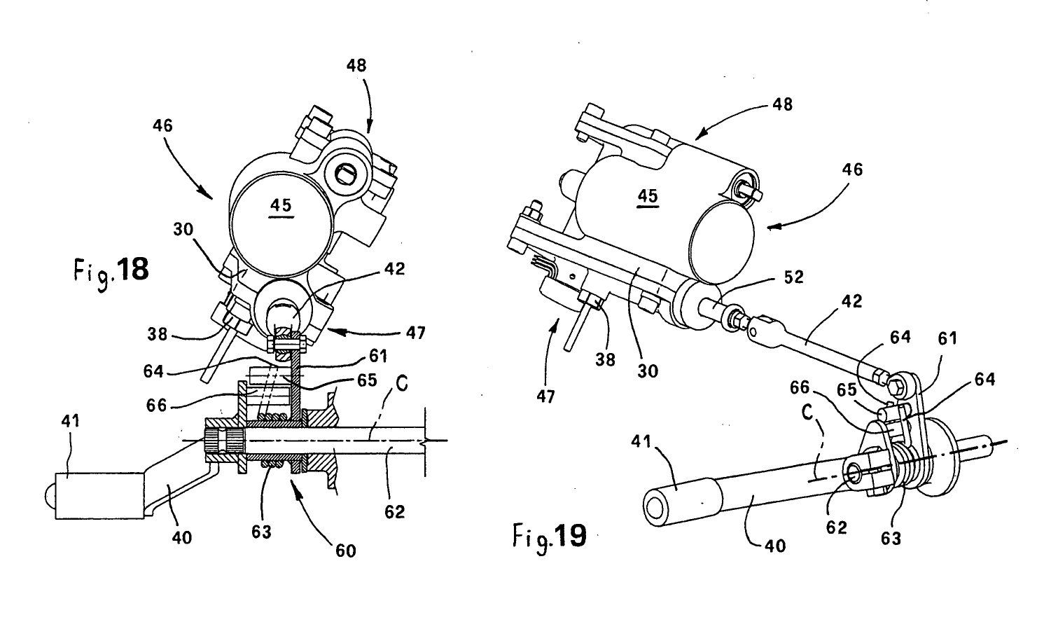

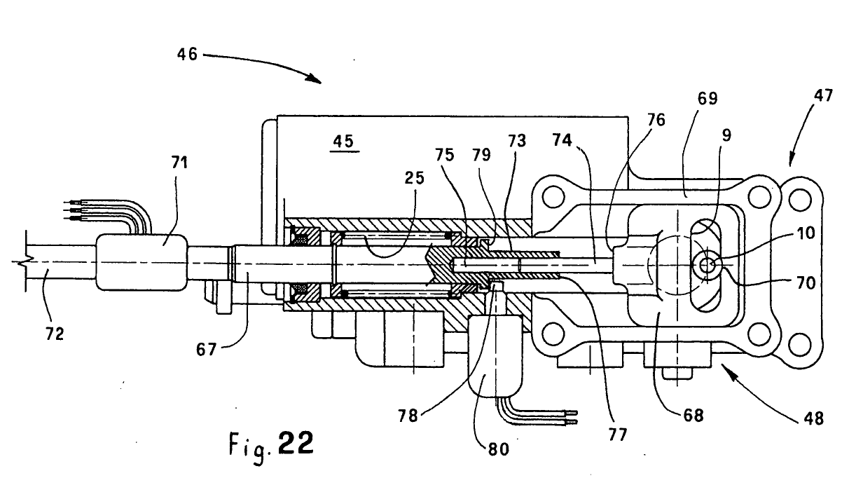

Moreover, the figures also show:
67, FIG. 20, the rigid rod rigidly connected to the sliding plate 68 in which there is template 9 for the crank stud 10;
69 the guide for the said sliding plate; 70, an indent for the precise definition of the angle of rotation of the stud 10 for the neutral position; 71 a load cell, to measure axial loads, positioned between the said rod 67 and the extension 72, to enable a fine adjustment of the moment of engagement of the clutch;
73, FIG. 22, the extremity of the said rod 67, in which there is a rigid unidirectional coupling with the said sliding plate 68;
the said connection consists of a rod 74 rigidly connected to the said plate 68 coupled with axial sliding in a corresponding groove 75 made in the rod 67: during the thrust motion, the shoulder 76 of the said plate 68 and the front surface 77 of the said extremity are in contact;
78, the locking tooth of the said rod 67, which presses against an axial shoulder 79 made in said extremity 73;
80, the electromagnet activating the said locking tooth 78, when in neutral position being disengaged.

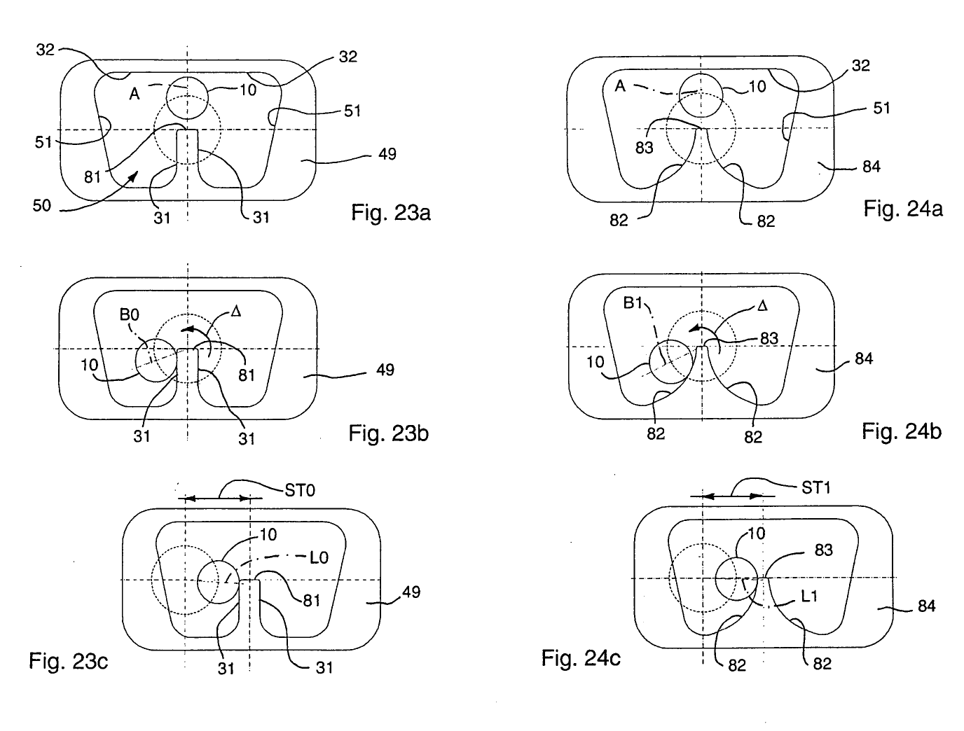

In order to understand the functioning of the actuator means for the gearbox, it may be considered the first embodiment of the template shown in FIGS. 23a, 23b, and 23c with different position of the stud 10 during rotation cycle. The position A is the null position and after a rotation Δ the stud starts the stroke of the plate 49 in B0 and stops the stroke in L0 generating a stroke ST0 with a sinusoidal path, i.e. with a slow ramp as a consequence of the profiles 31 of the template and of the position of the top 81 of the profiles 31 related to the axis of rotation of the stud 10.

An improved template profile may be seen in FIGS. 24a, 24b and 24c that show a second embodiment of the profiles 82 that have a top 83 similar to the top 81. After a rotation A, the stud 10 starts the stroke of the plate 84 in B1 and stops the stroke in L1, thus generating a stroke ST1 equal in length to ST0, but with a less sloped path: the timing of the full stroke ST1=ST0 may be quicker than those of the profiles 31 and the timing to maintain the actuator in full stroke position, even if the continuous rotation Δ may be adjusted by changing, raising or lowering the position of the top 83.

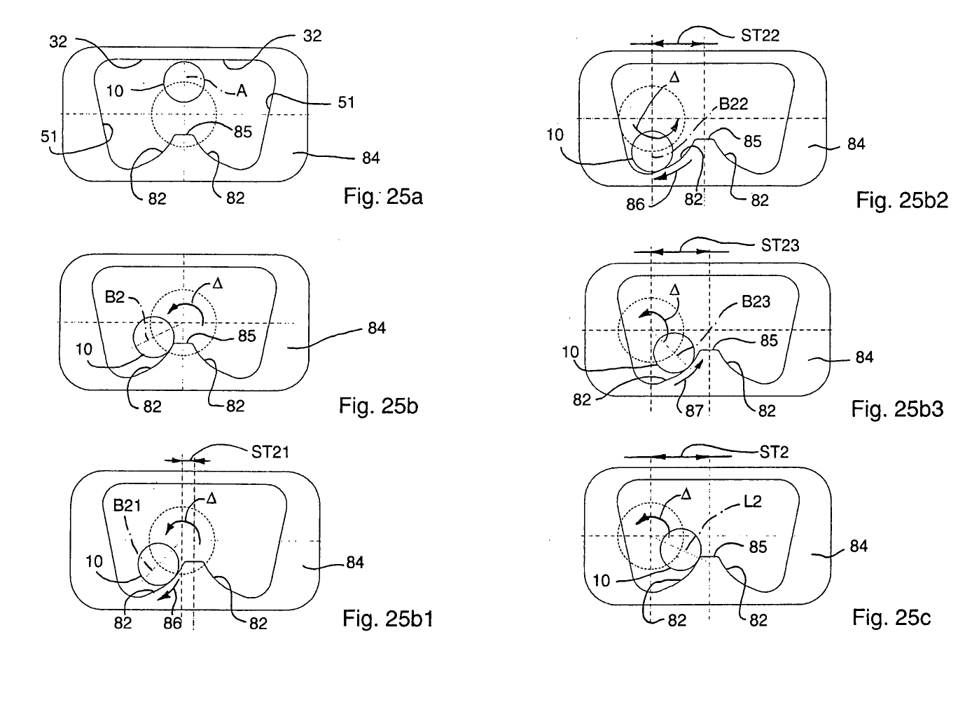

The way to achieve the best performances by the template profiles can be seen in FIGS. 25a, 25b, 25b1, 25b2, 25b 3 and 25c in which a third embodiment of the plate 84 shows the profiles 82 with a lower top 85 of the profiles 82 of the template. During a rotation Δ the stud 10 starts the stroke of the plate 84 in B2 and stops the stroke in L2, thus generating a stroke ST2; the timing of the stroke path is equal to the second embodiment, but in order to maintain the actuator in full stroke position for a minor timing than the previous embodiment, even if the rotation Δ continues, the lowering of the top 85 achieves the stop of the stroke at L2, i.e. before the previous timing L1=L0. This effect is obtained by rendering the curvature of the profiles 82 similar or equal to the sum of the radius of the crank and the radius of the stud 10, in order to render the stroke ST22 very similar to the strokes ST23 and ST2. The relative motion between the stud 10 and the plate 84, even with a constant rotation Δ, changes direction: after B2, the relative motion 86 is opposite to the rotation Δ, but after B22, the relative motion 87 has equal direction to Δ rotation.

Obviously, the above-described A rotation may be rendered in the opposite sense of rotation to that shown in the figures: the symmetrical constitution of the profiles 31 or 82 of the template permits to obtain the same stroke path but in the opposite direction.

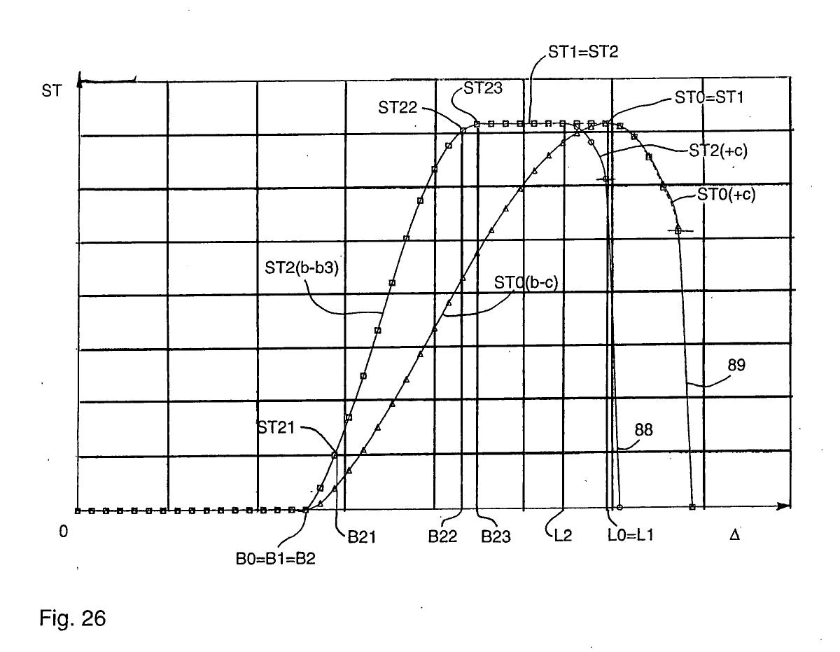

Finally, in FIG. 26 it may be seen a diagram with the comparison of the three different embodiments of the template for the gearbox actuator means. In order to understand the comparison, the three diagrams are shown with rather different scales to have the same starting point B0=B1=B2 and the same stroke length ST0=ST1=ST2. The ramps, i.e. the sloped paths of the diagrams, are rather different from the ST2(b-b3), due to the profile 82, which is stepped to the ST0(b-c), due to the profile 31, and the timing of constant stroke, i.e. the actuator means are kept in an actuating position for a longer time, which is due to the conformation of the profile 82 with the radius similar to the sum of the radius of the crank and the radius of the stud 10. Different heights of the position of the top 81 or 83 in respect of top 85 clearly modify the timing of the stop of the stroke, L0=L1 compared to L2. The final curves of the diagrams ST2(+c) and ST0(+c) show the disengaging paths of the stud 10 from the template profiles; subsequent lines 88 and 89 indicate a free motion of the plate, i.e. a return to the central position, after the disengagement of the stud.

Operation of the hydraulically operated clutch actuator is as follows. The actuator may be placed in any convenient location in the vehicle and has the hydraulic connection 7 with the tube to the actuator cylinder of the clutch, of known type, and the servo control acts with an electric signal to the motor reducer in the moment the clutch is operated. When the command is given the rotation of the crank stud 10 generated by the motor reducer is effected with a speed that rapidly enables the thrust on piston 3 to achieve a response from the clutch suitable to the operating conditions of the vehicle at that moment. The said stud rotating and pushing the template 9 towards the said piston generates the axial movement of the pump 2 that sends pressurized oil through connecting tube 7 to the clutch. In the last portion of rotation of the button 10 the return stroke of the plate 8 is counteracted by the thrust of spring 16 acting on the plate by means of cup 15, to counteract the forces generated by the springs in the clutch. Finally, sphere 17 entering into the groove 19 selects the neutral position of the said crank stud 10 in contact with the template 9. In this position the plate is only pushed by the spring 16, preloaded, whereas on the opposite side the forces of the clutch are balanced inside the clutch itself and by the hydraulic connection 6 between the cylinder 4 and the tank 5.

Comparing the operation of the actuator described above with the load-displacement diagram, the crank stud 10, FIG. 9, once beyond the neutral position dead-point, FIG. 3, there is a first section CD in which the stud 10 is propelled by the spring 16 without encountering resistance, due to the stroke required by connection 6 for hydraulic sealing: the motion occurs with the maximum acceleration that the inertia of the motor reducer mechanism allows, reaching close to point R; then in the section CD, still under the action of the spring which overcomes the counter forces generated in taking up the slack caused when disengaging the clutch, in the diagram the load passes along line G with a very small displacement from R to D. Subsequent displacement, from the position of FIG. 4 to that of FIG. 6 is represented from point D to F in the diagram with a variation in load, acting on the said stud 10, still under action of the spring 16 for the first half of displacement, and then only subsequently does the motor reducer have to overcome the forces to achieve complete disengagement of the clutch arriving at F: the load that has to be counteracted in normal known clutches has been found to be between 0 and 30 dan.

In the subsequent phase of clutch engagement, from FIG. 6 to FIG. 8, the thrust of the clutch from F towards I aids rotation of the crank stud in the first part, then as described for the disengagement, the subsequent section it is of a reduced value due to the difference in the pre-loading of the springs of the clutch and the compensation spring 16; in the last section with displacement Cl of FIG. 8 the stud 10 has to overcome the entire force of the spring 16, passing from point I to point R along load vector G: this displacement occurs at the end of the cycle without affecting it, the load generated by the electric motor reducer may be controlled by the conformation of the thrust face of the template 9. The said template, in the case of a rectilinear or straight face, with respect to the direction of displacement of the plate 8, has a sinusoidal relationship of the reduction of the tangential load actually acting on the motor reducer, with respect to the load generated by the spring 16, thereby assisting in reaching the initial position in FIG. 3. From the foregoing emerges the possibility of shaping the face of the template 9 on the side of the compensating spring 16, but also of 25 with the metal cable 22, to minimize the torque acting on the motor reducer in the above mentioned displacement Cl: the resulting profile has an inclined section with variation of the inclination close to the neutral position. Finally, with this actuator, the profile of the template 9 can be made with a geometry that define displacement relationships for clutch disengagement and engagement that allow specific responses of the clutch to be achieved; this is possible with actuator 1, whether it rotates in one direction or whether it rotates in both directions, when coupled with the gearbox actuator 27.

In the subsequent configuration operation by metal cable 22, FIG. 3, operation is analogous, with the difference of the pulling action, and not thrust, applied by the said cable, as shown in FIG. 1; the neutral position of the said crank stud 10 is achieved with the play introduced between the extremity of the said cable 22 and the clamp 24 holding the said cable, positioned at the end of the stem 23: the compensation spring 25 has its maximum load in that position.

In this way, the shape of the template 9, as described earlier, may, advantageously have a non linear profile designed to achieve displacement relationships of the plate which vary in function of the positions of the crank stud 10, which may thereby conveniently be adjusted in function of the forces acting on the mechanism.

Operation of the sequential gearbox actuator, FIG. 4, is as follows. The power assisted control that acts on the clutch, as described earlier, also acts as control for the sequential gearbox actuator: as the crank stud 10 rotates it engages with one of the two profiles 31 and acting on plate 28 displaces it, the choice of profile depends on the direction of gear selection, either a higher gear or a lower one, and therefore on the sense of rotation of the stud 10; the pin 13, is in turn pushed by plate 28 under the action of the compensation spring 36, so as to act on the rod 33 connected with rods 40 and lever pedal 41. The control stroke of the gearbox is shorter than stroke of the said plate 28, the compensation of the springs 36 ensuring the gearbox stroke is completed, ensuring proper operation.

The engagement with the guiding profiles 31 of plate 28 is advantageously set after at least a quarter of a rotation of the stud 10 to enable the motor reducer to start in total absence of resistance and, furthermore, to engage with profile 31 with tangential motion so as to avoid shocks; the delay in the activation is also advantageous in its use in conjunction with the clutch actuator, allowing the clutch actuator to intervene before the gearbox actuator.

Furthermore the two profiles 32 enable the operator to use the sequential gearbox manually, without the intervention of the power assisted control and the actuator: the stud 10 can remain in its neutral position, shown in FIG. 4, while the plate 28, moved by the external lever system, pedal 41, lever 40, rod 42 and rod of extension 39, does not encounter obstructions during its stroke, thereby allowing manual operation.

Moreover, the configuration of the template 50, with its straight profiles 51, makes it easy to operate in all conditions, enabling even a manual change by the driver while the actuator 47 is operating; a further safety feature is the mechanical disconnecting mechanism, in both its axial configuration 53 and its rotational configuration 60, ensuring a rigid connection between the parts with limited levels of load, in the case of the axial disconnecting mechanism, or limited torque in the case of the rotational disconnecting mechanism. The effect of the disconnecting mechanisms is to allow over-run of the actuator 47 without damaging the sequential gearbox whilst at the same time ensuring that control stroke is completed.

The configuration of template for the gearbox actuator means described in FIGS. from 23 to 26 is enabled to obtain a timing needed by a specific gearbox; moreover the radius of the profiles 82 may be slight different on the two profiles of the same template, as a specific gearbox may require said difference.

Operation of the double actuator 1, 27, FIG. 7, is as in the respective single actuators for the clutch and the sequential gearbox: the coupling of the two respective studs 10 is made conveniently with the required phase angle of one with respect to the other, whereas for the sense of rotation of the motor reducer 45, whilst being indifferent for the clutch control, is not indifferent for the sequential gearbox. The coupling of the two crank studs 10 and their respective plates 8 or 21, and 28 is in any way possible and very convenient, with the two actuators performing a simultaneous and synchronized control stroke using a single driving device. Consequently a lack of synchronization between the gearbox and the clutch is always avoided.

The clutch actuator 48, as shown in FIGS. 20 and 22, has a rigid control rod 67, and its extension 72, separated by load cell 71 which continuously measures the value of the load applied between the actuator 48 and the clutch, here not shown. The resulting signal is analyzed by the electronic processor which controls the phase modulation of engagement of the said clutch. An analogous effect of phase modulation of the clutch engagement may also be obtained in the hydraulic control of the clutch as in FIGS. 1 and 2, having in the control tube, that is, downstream of the pump 2 and upstream of the cylinder activating the said clutch, a sensor for measuring the pressure of the hydraulic liquid, which is, as known, proportional to the load on the rod of the clutch.

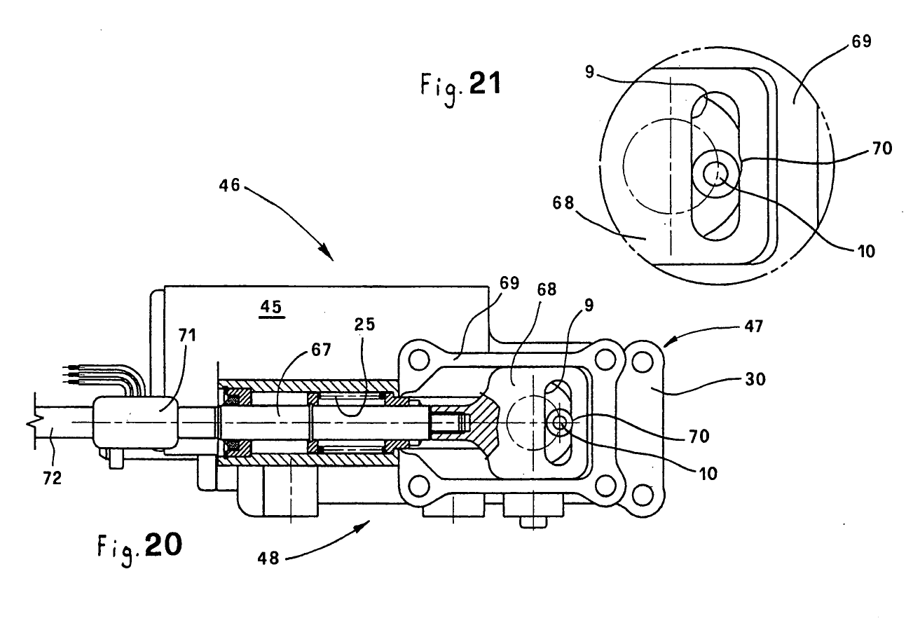

FIGS. 20 and 21 show the indent 70, a variation of indent 19, in which the crank stud 10 engages when in its neutral position with clutch engaged allowing a precise positioning of the actuator 48, by way of the compensating action of the spring 25 on the sliding plate 68 with template 9.

Operation of the locking tooth 78, shown in FIG. 22, is achieved by activating the controlling electromagnet 80 causing the said tooth to engage with the axial shoulder 79 of the extremity 73 of the rod 67: the said shoulder allows the thrust stroke, but does not allow the reengagement of the clutch thereby enabling the actuator to perform a number of consecutive rotations of the stud 10 without operating the clutch; this possibility is very useful when carrying out more the one gear changes, usually when changing down, enabling the clutch engagement phase to be skipped when changing several gears simultaneously; Once the multiple gear change phase is completed the electronic control processor deactivates the electromagnet, thus enabling the final engagement stroke of the clutch to be carried out.

In practice the materials, the dimensions and details of execution may be different from, but technically equivalent to, those described without departing from the juridical domain of the present invention.

For instance, though less advantageous, instead of the said linear templates, that is, generating a sinusoidal displacement relationship, thrust crank mechanisms may be used, which in function of the length of the piston rod used approach the said sinusoidal relationship. Furthermore, as an alternative to rod 39 in the gearbox actuator 27 the actuation may be transmitted by means of metal cables. Also, the straight profiles 51 may be in whichever way profiled or curved to join said profiles 31-32 (and 32-31) following on from each other. Finally the axial shoulder 79, in the case of the locking tooth 78 for keeping the clutch actuator 48 in the open position may be obtained with an annular hole, or even an axial slot, in the said extremity 73, with an appropriate axial extension to enable an adequate movement in the said slot to compensate the displacement of the rod 67 in the over-runs generated by the sliding plate 68.

1-26. (canceled)

27. An actuator that controls a motor vehicle transmission, like a clutch, a gearbox and so on, the type of which comprises:
an electric motor,
a rod traveling with straight-line motion along a direction to control the transmission,
a mechanism for transforming rotary motion of the electric motor into straight-line motion of said rod, wherein, the mechanism comprises:
a crank, with a crank stud, driven by the electric motor, around a full revolution or turn, and
at least a cam, connected to said rod, said cam having a couple of profiles engaged by said crank stud.

28. An actuator according to claim 27, wherein said cam is substantially a plate having a slot, with opposite sides, forming said profiles, said slot being engaged by said stud to control a clutch.

29. An actuator according to claim 27, wherein said cam is substantially a tooth having opposite sides forming said profiles, alternatively engaged by said stud, driven clockwise and counterclockwise, against elastic means, to control a gearbox.

30. An actuator according to claim 29, wherein a rod controlling a gearbox is centered mechanically by the mechanism of the actuator by means of counter-acting springs constituting said elastic means.

31. An actuator for controlling a sequential gearbox in motor vehicles, according to claim 29, wherein the cam is fashioned in a template and consists of the two profiles and a top between profiles at least.

32. An actuator, according to claim 31, wherein the template presents the top between the two profiles registered in height to define the timing of stand in full stroke position.

33. An actuator for controlling a sequential gearbox in motor vehicles, according to claim 29, wherein the actuator has a mechanical disconnecting mechanism, with preloaded elastic element, positioned between the said electric actuator and a control pin of the sequential gearbox.

34. An actuator according to claim 33, wherein the mechanical disconnecting mechanism has an axial operating direction and is positioned directly on a control lever of the sequential gearbox.

35. An actuator according to claim 33, wherein the mechanical disconnecting mechanism intervenes directly on the rotation of the pin of the sequential gearbox controlled by a rod of the said actuator of the gearbox.

36. An actuator according to claim 34, wherein the mechanical disconnecting mechanism consists of a preloaded helical spring, positioned in a seat whose an internal part of the mechanism is rigidly connected to a control rod of the gearbox, whereas an external part of the mechanical disconnecting mechanism is rigidly connected to a section of rod which is an extension of the preceding control rod.

37. An actuator according to claim 35, wherein the mechanical disconnecting mechanism is positioned on the axis of the control pin of the mechanism, having a rotational spring wound on the control pin and the spring end portions preloaded to hold pins, one with an end portion rigidly fixed to an arm, and the other with an end portion rigidly fixed to a control pedal of the gearbox, in turn splined on the control pin of the sequential gearbox.

38. An actuator according to claim 28, wherein the cam profiles being shaped with bilateral contact with the crank stud.

39. An actuator according to claim 28, wherein the actuator presents elastic means allowing energy accumulation; the elastic means being associated to said rod, to compensate the forces generated by internal springs of the clutch.

40. An actuator according to claim 28, wherein the actuator has a mechanism comprising a hydraulic pump connected to the rod.

41. An actuator according to claim 28, wherein the actuator has an unidirectional rigid connection between the plate and the rod; the actuator having also a locking tooth of the rod, or an extremity of it, to abut against a shoulder or in a slot made in the rod; the said tooth is disengaged when controlled by means of an electromagnet in its de-energized position.

42. An actuator according to claim 28, wherein a metallic cable is connected to said plate.

43. An actuator that controls a clutch and a gearbox of a motor vehicle, comprising:
an electric motor,
a clutch rod and a gearbox rod, traveling with straight-line motion along a respective direction and connected to said motor by a respective mechanism for transforming rotary motion of the electric motor into
at least a cam, connected to said rod,
wherein the mechanism to drive the clutch rod comprises:
a crank with a crank stud, driven by the electric motor, around a full rotation, and
a cam, connected to said clutch rod,
said cam being substantially a plate having elongated slot with opposite sides engaged by said stud; and
the mechanism to drive the gearbox rod comprises:
a crank, with a crank stud, driven by the electric motor, around a full rotation, and
a cam, connected to said gearbox rod,
said cam being substantially a tooth having opposite sides, alternatively engaged by said stud driven clockwise and counterclockwise against elastic means and wherein
the two crank studs being angularly spaced apart by 90°.

44. Set for modifying the control of a clutch and of a gearbox of a motorcycle, comprising at least an actuator comprising:
an electric motor,
a clutch rod and a gearbox rod, traveling with straight-line motion along a respective direction and connected to said motor by a respective mechanism for transforming rotary motion of the electric motor into
at least a cam, connected to said rod,
wherein the mechanism to drive the clutch rod comprises:
a crank with a crank stud, driven by the electric motor, around a full rotation, and
a cam, connected to said clutch rod,
said cam being substantially a plate having elongated slot with opposite sides engaged by said stud; and
the mechanism to drive the gearbox rod comprises:
a crank, with a crank stud, driven by the electric motor, around a full rotation, and
a cam, connected to said gearbox rod,
said cam being substantially a tooth having opposite sides, alternatively engaged by said stud driven clockwise and counterclockwise against elastic means and wherein
the two crank studs being angularly spaced apart by 90°.
